(19) United States
(12) Patent Application Publication
(10) Pub. No.: US 2011/0111918 A1
(43) Pub. Date: May 12, 2011

(54) BEVEL FRICTION RING GEAR

(76) Inventor: Ulrich Rohs, Dueren (DE)

(21) Appl. No.: 12/737,168

(22) PCT Filed: Jun. 25, 2009
(86) PCT No.: PCT/DE2009/000880

§ 371 Date: Dec. 14, 2010

(30) Foreign Application Priority Data
Jun. 26, 2008 (DE) 10 2008 029 945.6
Mar. 20, 2009 (DE) 10 2008 013 701.7

(51) Int. Cl. F16H 55/32

(52) U.S. Cl. 476/7; 476/67

(57) ABSTRACT

According to the invention, a bevel friction ring gear which transmits torque between the two bevels with both bevels mounted on a chassis by bearings may be provided which has a still greater efficiency, wherein at least one of the bevels has a bearing to both sides and that the first of the bearings is sealed relative to the bevel and the second of the bearings is open with relation to the bevel.

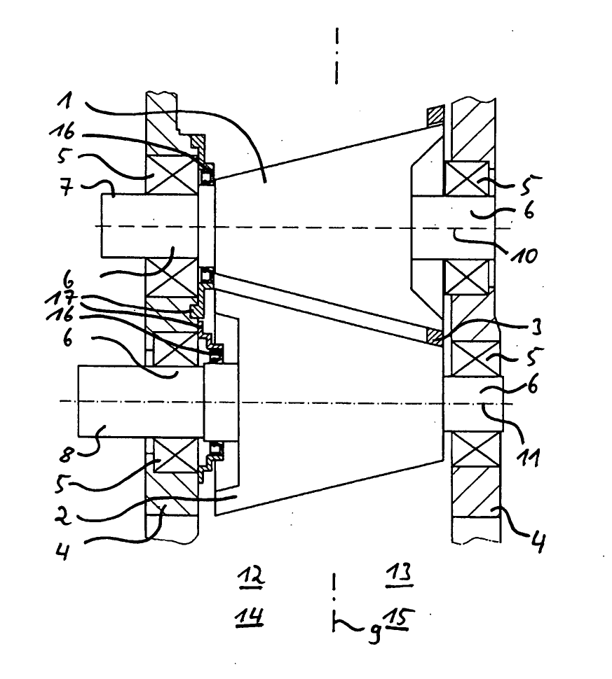

The invention relates to a bevel friction ring gear comprising two bevels and a friction ring, which transmits torque between the bevels, both bevels being respectively mounted on a chassis by a bearing.

Such bevel friction ring gears are already known sufficiently from, for example, EP 0 878 641 A1, this publication already disclosing the use of a traction fluid, in this regard a traction fluid chamber using corresponding bearing seals, which are arranged in each case on the side of bearings facing the bevel chambers, said bearings bearing the bevels on a chassis.

Thus it has been shown that separate fluid chambers comprising a traction fluid, on the one hand, and a lubricant, on the other hand, improve the properties of such a bevel friction ring gear, in particular relative to bevel friction ring gears which operate entirely without fluid, but also relative to gears which only use lubricant or only use traction fluids, and permit a greater level of efficiency.

It is the object of the present invention to provide a generic bevel friction ring gear which has an even greater level of efficiency relative thereto.

As a solution, a bevel friction ring gear comprising two bevels and a friction ring is proposed which transmits torque between the two bevels, both bevels being respectively mounted on a chassis by bearings, and the bevel friction ring gear being characterised in that at least one of the two bevels has a bearing on both sides and in that a first of the two bearings is sealed relative to the bevel and a second of the two bearings is open relative to the bevel.

Although ultimately a compromise has to be made with regard to low-loss running of the open bearing, on the one hand, and good traction between the friction ring and the bevel, on the other hand, relative to the open bearing, generally it appears possible to improve the overall level of efficiency of a bevel friction ring gear with an appropriate design, which would also appear to be because a corresponding compromise only has to be made with regard to one of the bearings. In this regard, the sealed bearing may be accordingly designed to be more robust and be used for absorbing a large proportion of the bearing forces, in particular in specific operating conditions. On the other hand, it is accordingly possible to take the load off open bearings as far as possible, in particular in suitable operating conditions, in order to avoid in this manner inappropriate effects of a fluid with a relatively high traction effect. In this connection, it is understood that also other suitable measures, for example the choice of suitable materials or coatings and locally defined conveying devices or the like for transporting the traction fluid away from the open bearing, may advantageously be used. Also, the sealing friction which is not present on the open bearing accordingly appears to be regarded as a positive feature regarding the resulting losses, an absence of all bearing seals, however, not leading to a correspondingly advantageous level of efficiency.

In the present connection, the term “sides” is to be interpreted as broadly as possible, and respectively relates to a plane positioned through the bevel friction ring gear, by which the two sides are accordingly defined. Referring to just one bevel, the term “side” preferably refers to the plane which intersects the bevel axis vertically and which is arranged within the bevel.

Generally, the at least one bevel has a rotary connection on only one connecting side. This may, for example, be a corresponding rotary drive or a corresponding rotary output. This is generally because further gear members or drives are arranged in each case upstream and/or downstream of a bevel friction ring gear, before the torque is transmitted, for example, to the wheels of a motor vehicle. Such gear members may, for example, be a reverse gear or a differential gear. An internal combustion engine is provided as a drive, for example, which accordingly may act on only one side of an input bevel. Preferably, in such an embodiment, the bearing located on the connecting side is sealed, as generally on this connecting side further gear members are arranged, such as for example the aforementioned engine or even the aforementioned differential and/or the aforementioned reverse gear. In this manner, the corresponding bearing may be directly lubricated and/or cooled via lubrication of these gear members. As, in contrast, the other bearing is of open configuration, no further gear members being generally provided on this side, however, the above-mentioned advantages may therefore be immediately implemented.

As a bevel friction ring gear generally has at least two bevels, optionally one of the bevels also being able to be a cylindrical roller, accordingly it is advantageous if both bevels have in each case a bearing on both sides, and in each case a first of the two bearings is sealed relative to the respective bevel and a second of the two bearings is open relative to the respective bevel. In this regard, the advantages explained above for one bevel may be implemented in both bevels. The same would apply if the bevel friction ring gear were to have further bevels.

The aforementioned advantages increase if the bevel friction ring gear has two sides and the two open bearings of the two bevels are arranged on the same side.

The latter applies, for example, if the bevel friction ring gear is fastened to an engine block and the open bearings are arranged on the side remote from the engine block. Generally, the entire arrangement of the engine block and gear terminates on this side, so that it is possible to dispense with separate supply lines of lubricant or the like on this side.

Cumulatively and/or alternatively, it may be advantageous if the bevel friction ring gear has an overdrive side, i.e. a side with a high gear ratio, and the open bearings are arranged on the overdrive side. According to the invention, lower contact forces are required in overdrive, so that it is assumed that the drawbacks of a traction fluid, namely the increased frictional values in the bearing, do not have such significance.

Relative to the sealed bearing, the drawback of the traction fluid with its increased frictional losses in the bearing is moreover reduced by, on the other hand, being able to dispense with a seal which has the sealing friction associated therewith. This is, in particular, advantageous if the bevel has a rotary connection on only one side and the open bearing is provided on the other side, as then the bearing, and at the same time the chamber comprising the bevels on the side of the bearing remote from the bevel, may be sealed via a simple cover or the like.

In the present connection, it is understood that each bearing is regarded as the “bearing open on one side” which on its corresponding side has no contact seal, accordingly in this regard, for example, a labyrinth seal being also denoted as “open”.

On the other hand, it is understood that an open bearing is preferably sealed on its side remote from the bevel, so that traction fluid may not leave the bevel friction ring gear or reach regions of the bevel friction ring gear in an undesired manner and contaminate said regions.

The sealing preferably takes place so that said seal provided on the side of the open bearing remote from the bevel encompasses a bearing pin of the bevel in a contactless manner. In this manner, frictional losses, which, in particular, may be caused by a contact seal, may be avoided.

Preferably, the seal provided on the side of the open bearing remote from the bevel forms a fluid chamber, the axial extension thereof being smaller than the wall thickness of the chassis in the region of the open bearing. By such an embodiment, too large a fluid chamber may be avoided, in which an unnecessarily large amount of traction fluid may accumulate which ultimately only leads to losses.

Cumulatively and/or alternatively, in order to avoid as far as possible an accumulation of traction fluid, the seal provided on the side of the open bearing remote from the bevel may form a fluid chamber which does not taper relative to the open bearing. Potential traction fluid may easily flow in the direction of the bearing and pass again through said bearing into the region in which the bevels are arranged. It is understood that, alternatively, suitable return lines, such as bores or channels, may also be provided which, however, is relatively costly.

The advantages explained above are produced, in particular, when naphthene is used as traction fluid. It has been shown surprisingly that naphthene oil, in spite of its excellent capacity to transmit a torque in a frictional manner between two surfaces, as required for a traction fluid in a bevel friction ring gear, does not damage a bearing which bears the bevel of a bevel friction ring gear, although actually corresponding pressure, force and frictional conditions also have to be taken into account in the bearing. It is assumed that the substantially smaller contact surfaces between the rolling bodies of the bearing, on the one hand, and the running surfaces of this bearing, on the other hand, contribute to this surprising effect. However, advantageously this embodiment also appears able to be implemented in friction bearings. In this regard, it is understood that the use of naphthene oil in bevel friction ring gears may also be correspondingly advantageous, irrespective of the remaining features of the present invention, as the surprising effect indicated above may also be correspondingly used at a different location of a bevel friction ring gear.

Further advantages, aims and features of the present invention are explained in the following description of the accompanying drawings. In the drawings:

the only FIGURE shows a schematic side view of a bevel friction ring gear according to the invention.

The bevel friction ring gear shown in the FIGURE has an input bevel 1 and an output bevel 2, which are mounted spaced apart by a gap in a chassis 4, the gap being bridged by a friction ring 3 which encompasses the input bevel 1 and may be displaced in the gap. The displacement permits, therefore, a stepless alteration of the gear ratio between the two bevels 1, 2.

The mounting of the two bevels 1, 2 takes place via bearings 5 (merely shown schematically) which ultimately may be configured in any manner, for example as conical roller bearings, self-aligning roller bearings, ball bearings, cylindrical roller bearings or even as friction bearings.

In the present exemplary embodiment, the bevels 1, 2 are mounted in each case on bevel pins 6. It is understood that also other embodiments of bearings may be provided, for example an internal bearing arrangement within a recess of a bevel.

In the present exemplary embodiment, the bevel pin 6 arranged at the pointed end of the input bevel 1 is configured as an input shaft pin 7 and, in a manner known per se and thus not shown further, is able to be connected to a drive, for example to a motor vehicle engine. The shaft pin 6 arranged on the wide end of the input bevel 6, however, does not transmit any torque in this exemplary embodiment. Accordingly, the input bevel 1 only has one rotary connection, namely the drive shaft pin 7.

In a similar manner, the bevel pin 6 arranged on the pointed end of the output bevel 2 also does not transmit any torque. On the side remote from the bevel tip of the output bevel 2, i.e. on the wide side of the output bevel 2, the corresponding bevel pin 6 is configured as an output shaft pin 8 and, in a manner known per se and thus not shown further, operatively connected to an output pinion (not shown). It is understood that relative thereto any other type of output may also be provided, for example via a belt. As immediately obvious, therefore, the output bevel 2 also has a rotary connection, namely the output shaft pin 8 on only one of its sides.

A plane 9 (indicated in dashed lines) may be located through the two bevels 1, 2, and which intersects the input bevel axis 10 and the output bevel axis 11 vertically. Relative to the plane 9, two sides 12 and 13 may be defined, one respective bearing 5 being able to be associated with each bevel 1, 2. It is understood in this connection that the plane 9 does not necessarily have to be arranged centrally with regard to the bevels 1, 2. For a definition which is more reliable in terms of operation, it is sufficient if the plane 9 intersects the surface of the bevels 1, 2.

According to the present explanation with regard to the sides 12, 13, the side 12 may be defined as the connecting side 14, i.e. as the side on which the rotary connections are defined, as the drive shaft pin 7 and the output shaft pin 8 may be found there. Also, if the engine block is arranged immediately in the surroundings of the drive shaft pin 7, the side 12 may be defined as the side facing the engine block and the side 13 defined as the side remote from the engine block. Moreover, the side 13 as is visible immediately from the arrangement of the two bevels 1, 2, may be defined as the overdrive side 15, i.e. as the side with a high gear ratio.

The bearings 5 located on the side 12 are in each case sealed by sealing rings 16 which are respectively arranged on sealing ring carriers 17 which, in turn, are fastened to the chassis 4. As is immediately visible, such seals are not provided on the bearings 5 on the side 13. In such an embodiment, it is possible to wet the bevels 1, 2 and the friction ring with traction fluid, whilst this traction fluid does not reach the bearings 5 arranged on the side 12. Depending on the practical implementation, said bearings may, if required, be wetted by a lubricant which, in particular, is provided when such a lubricant is used in any case for the further gear members, such as for example a reverse gear or a differential.

The bearings 5 provided on the side 13, however, are reached by the traction fluid and thus are subjected to a correspondingly greater stress, sealing friction not being present at this point as sealing rings or other frictional seals are dispensed with, whereby the increased bearing friction caused by the traction fluid may be at least partially compensated.

In this connection, it is understood that the chassis 4 on the side 13 may be easily sealed and/or closed on its side remote from the bevels 1, 2 which, for example, may be implemented by a corresponding cover plate.

If now the region of the bevels is filled with a naphthene oil, the quantity of oil being adapted to practical requirements, in particular when the bevels rotate, this may also reach the bearings 5 on the side 13, and be used there as coolant, as explained above.

### LIST OF REFERENCE NUMERALS

1 Input bevel
2 Output bevel
3 Friction ring
4 Chassis
5 Bearing
6 Bevel pin
7 Drive shaft pin
8 Output shaft pin
9 Plane
10 Input bevel axis
11 Output bevel axis
12 Side
13 Side
14 Connecting side
15 Overdrive side
16 Sealing ring
17 Sealing ring carrier

1. A bevel friction ring gear comprising two bevels and a friction ring, which transmits torque between the two bevels, both bevels being respectively mounted on a chassis by bearings, wherein at least one of the two bevels has a bearing on both sides and wherein a first of the two bearings is sealed relative to the bevel and a second of the two bearings is open relative to the bevel.

2. The bevel friction ring gear according to claim 1, wherein the at least one bevel has a rotary connection on only one connecting side, for example an output shaft pin or a drive shaft pin, and wherein the bearing located on the connecting side is sealed.

3. The bevel friction ring gear according to claim 1, wherein both bevels have in each case a bearing on both sides, in each case a first of the two bearings being sealed relative to the respective bevel and a second of the two bearings being open relative to the respective bevel.

4. The bevel friction ring gear according to claim 3, wherein the bevel friction ring gear has two sides and the two open bearings are arranged on the same side.

5. The bevel friction ring gear according to claim 4, wherein the bevel friction ring gear is fastened to an engine block and the open bearings are arranged on the side remote from the engine block.

6. The bevel friction ring gear according to claim 4, wherein the bevel friction ring gear has an overdrive side, i.e. a side with a high gear, and the open bearings are arranged on the overdrive side.

7. The bevel friction ring gear according to claim 1 wherein the bearing which is open relative to the bevel is sealed on its side remote from the bevel.

8. The bevel friction ring gear according to claim 7, wherein the seal provided on the side of the open bearing remote from the bevel encompasses a bearing pin of the bevel in a contactless manner.

9. The bevel friction ring gear according to claim 8, wherein the seal provided on the side of the open bearing remote from the bevel forms a fluid chamber, the axial extension thereof being smaller than the wall thickness of the chassis in the region of the open bearing.

10. The bevel friction ring gear according to claim 8, wherein the seal provided on the side of the open bearing remote from the bevel forms a fluid chamber which does not taper relative to the open bearing.

11. The bevel friction ring gear according to claim 1, comprising naphthene as traction fluid.

12. A bevel friction ring gear comprising two bevels and a friction ring, which transmits torque between the two bevels, both bevels being respectively mounted on a chassis by bearings, further comprising naphthene as traction fluid.
